(19) United States
(12) Patent Application Publication
(10) Pub. No.: US 2012/0296753 A1
(43) Pub. Date: Nov. 22, 2012

(54) Supplier/Buyer Commerce Network that Electronically Introduces Buyers and Suppliers

(75) Inventors: Robert M. Calderoni, Greenwich, CT (US); Kshitij Dayal, San Jose, CA (US); Bhaskar Himatsingka, Sunnyvale, CA (US); Robert Mihalko, Los Altos, CA (US); David Louis Morel, Nashville, TN (US); Henry Robinson, Sunnyvale, CA (US)

(73) Assignee: ARIBA, INC., Sunnyvale, CA (US)

(21) Appl. No.: 13/270,189

(22) Filed: Oct. 10, 2011

Related U.S. Application Data
(63) Continuation-in-part of application No. 13/176,020, filed on Jul. 5, 2011.
(60) Provisional application No. 61/488,744, filed on May 22, 2011.

(51) Int. Cl. G06Q 30/00

(52) U.S. Cl. 705/26.1

(57) ABSTRACT

Embodiments for methods, systems and apparatuses of a supplier/buyer commerce network electronically introducing buyer and suppliers are disclosed. One computer-method includes electronically harvesting information related to characteristics of at least one of the buyers and anonymizing the harvested information. The anonymously harvested information is presented to a selected set of the suppliers, and a formation of a business relationship is facilitated between suppliers who express an interest in the at least one buyer.

### RELATED APPLICATIONS

This patent application is a continuation-in-part (CIP) of U.S. patent application Ser. No. 13/176,020, filed Jul. 5, 2011, which claims priority to U.S. Provisional Patent Application No. 61/488,744 filed on May 22, 2011, which are all herein incorporated by reference.

### FIELD OF THE DESCRIBED EMBODIMENTS

The described embodiments relate generally to a supplier/buyer commerce network. More particularly, the described embodiments relate to a methods, apparatuses and systems for a supplier/buyer commerce network electronically introducing suppliers to buyers, and/or buyers to suppliers.

### BACKGROUND

Commerce networks provide a means for electronically connecting buyers and suppliers. Buyers can enhance their supplier network by being electronically connected to many different suppliers. As a result, a buyer may be able to obtain better selection and pricing, and the suppliers may be able to realize additional sales.

Suppliers would like to provide information that describes the supplier online. Additionally, suppliers want to port their offline (brick-and-mortar) reputations, references, and provide potential new customers with the ability to interact with those references.

There is a need for systems, methods and apparatuses for providing introductions between buyers and sellers of commerce networks.

### SUMMARY

An embodiment includes a computer-method of a supplier/buyer commerce network electronically introducing buyers and suppliers. The computer-method includes electronically harvesting information related to characteristics of at least one of the buyers and anonymizing the harvested information. The anonymously harvested information is presented to a selected set of the suppliers. Electronic introductions of interested suppliers to the at least one buyer are facilitated. The potential of formation of business relationship is facilitated between suppliers who express an interest in the at least one buyer.

Another embodiment includes another computer-method of a supplier/buyer commerce network electronically introducing buyers and suppliers. The computer-method includes electronically harvesting information related to characteristics of at least buyer, selecting a set of suppliers based on the harvested information of the at least one buyer, presenting the harvest information to the set of the suppliers, facilitating electronic introductions of interested suppliers to the at least one buyer, and facilitating the potential formation of a business relationship between suppliers who express an interest, and the at least one buyer.

Another embodiment includes a supplier/buyer commerce network that electronically introduces buyers and suppliers. The network includes a commerce network server that is operative to electronically harvest information related to characteristics of at least one of buyer. Further, the commerce network server is operative to anonymize the harvested information, and present the anonymized harvested information to a selected set of the suppliers. The commerce network server then facilitates electronic introductions of interested suppliers to the at least one buyer, and facilitates formation of a business relationship between suppliers who express an interest and at least one buyer.

Another embodiment includes a program storage device readable by a machine, tangibly embodying a program of instructions executable by the machine to perform a computer-method of a supplier/buyer commerce network electronically introducing buyers and suppliers. When executed, the computer-method electronically harvests information related to characteristics of at least buyer, anonymizes the harvested information, presents the anonymously harvested information to a selected set of the suppliers, facilitates electronic introductions of interested suppliers to the at least one buyer, and facilitates formation of a business relationship between suppliers who express an interest in the at least one buyer.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an example of a system that facilitates a supplier/buyer commerce network in electronically introducing buyer and suppliers

FIG. 2 is a flow chart that includes steps of an example of a method of harvesting and summarizing buyer information.

FIG. 3 is a flow chart that includes steps of an example of a method of matching a set of suppliers with a buyer, and electronically communicating with suppliers, and electronically introducing the suppliers to the buyer.

FIG. 4 is a flow chart that includes steps of an example of a method a supplier/buyer commerce network electronically introducing buyers and suppliers.

FIG. 5 illustrates an example of historical records of harvested and summarized buyer information.

FIG. 6 shows a schematic illustration of one embodiment of a computer system that can perform the methods of the described embodiment, and/or can function as, for example, a supplier/buyer commerce network that electronically introduces buyers and suppliers.

### DETAILED DESCRIPTION

The embodiments described include methods, systems and apparatuses for a supplier/buyer commerce network electronically introducing buyers and suppliers (that is, suppliers to buyers and/or buyers to suppliers). The embodiments expand the number of suppliers available to the buyer, and therefore, allow the buyer to obtain more favorable terms and broader selection. In addition, this allows sellers to market themselves to prospective buyers, and therefore expand their customer base. Additionally, the embodiments allow suppliers who are not presently a part of the supplier/buyer commerce network to be alerted of prospective buyers that one or more of the suppliers may be interested in introducing themselves to, thereby expanding the reach of the supplier/buyer commerce network.

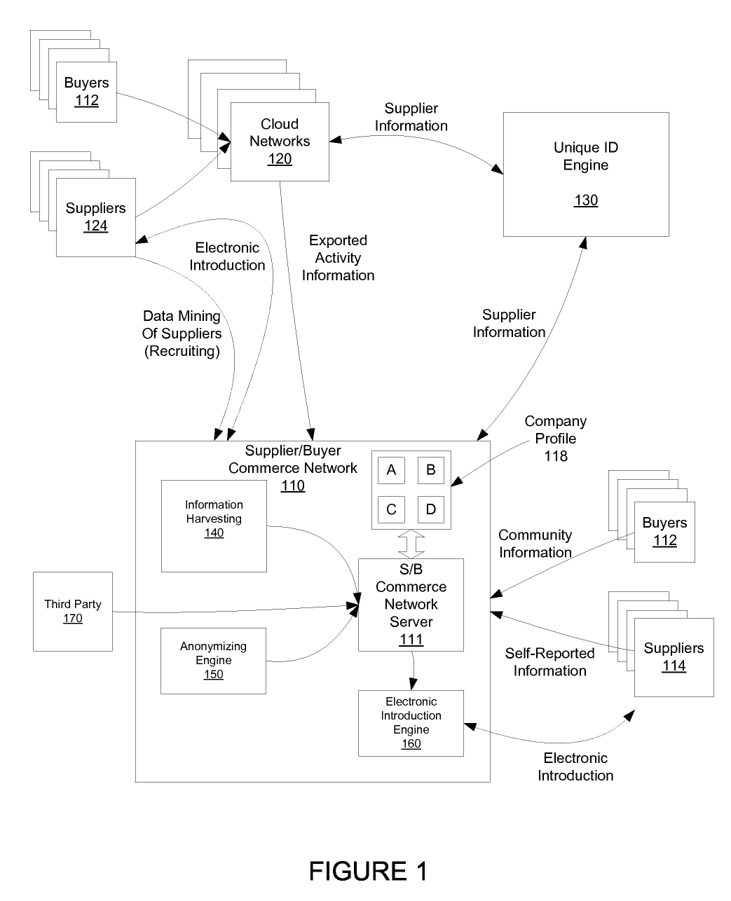

FIG. 1 shows an example of a system that facilitates a supplier/buyer commerce network 110 electronically introducing buyers 112 and suppliers 114, 124. Based on information harvested about buyers 112 (and in other embodiments, the suppliers as well) the supplier/buyer commerce network 110 electronically alerts suppliers 114, 124 of a interest by a buyer 112 to acquire good and/or services provided by the suppliers 114, 124, and facilitates electronic introductions of interested suppliers 114, 124 to the buyers 112.

Embodiments of the buyers 112 and the supplier 114, 124 are enterprise networks that include enterprise servers. The enterprise servers of the buyers 112 and the supplier 114, 124 are network connected (through, example, the internet) to the supplier/buyer commerce network 110. The supplier/buyer commerce network 110 can include servers that support the described embodiments for electronically introducing the buyers 112 and suppliers 114, 124. Embodiments of each of the servers include processors.

The buyers 112 are typically associated with the supplier/buyer commerce network 110 in some capacity. However, suppliers are not so limited. That is, the suppliers 112, 124 can be either associated (enabled) or not associated (not enabled) with the supplier/buyer commerce network 110. For example, as shown in FIG. 1, a first type of supplier 114 is associated with the supplier/buyer commerce network 110, while a second type of supplier 124 is not directly associated with the supplier/buyer commerce network 110, but can be reached through cloud networks 120 (through, for example, the internet).

Based on collected or harvested information of a buyer 112, the supplier/buyer commerce network 110 electronically (proactively) communicates information of the buyer 112 to one or more of the suppliers 114, 124. The information of the buyer 112 can be collected in one of several ways.

For an embodiment, the harvest information includes commodity information, such as, a commodity code of a good or service the buyer desires, a response information that indicates the time period in which the buyer would like to acquire the good or service, a product or service amount (cost or quantity), and a location (such as, at the country level). Additionally, the harvested information can include anonymous buyer information.

As shown, an embodiment includes an information harvesting engine 140 managing the information collection, which can include information from the company profile 118 of the buyer. For embodiments, the company profile includes at least four quadrants that include at least a first quadrant (A) that includes self-reported information, a second quadrant (B) that includes community information, a third quadrant (C) that includes third party information, and a fourth quadrant (D) that includes aggregated activity information.

For an embodiment, the anonymizing engine 150 anonymizes the harvest buyer information. For embodiments, this includes removing information that allows tracing of the information back to the buyer. This can include, for example, redacting information within the harvested information that could be used to identify the buyer. For an embodiment, the harvested information is anonymized as selected by the buyer.

Embodiments can further include summarizing the harvested buyer information. For at least some embodiments, this includes adding selected information of the buyer. That added information can include, for example, buyer information related to commodities, location, project size, industry, revenue, state, employees, years in business, dollar amount sourced on the supplier/buyer commerce network 110, and/or typical commodities sourced. This added information provides the suppliers with information about the buyer that currently desires a good or service that the supplier provides.

Based on the anonymized and harvested information of the buyers 112, suppliers 114, 124 are selected that are a reasonable match for the good or service being desired by the buyers 112. As previously mentioned, the supplier 114, 124 can be either associated with the supplier/buyer commerce network 110 or not associated with the supplier/buyer commerce network 110. Embodiments include selecting a set of the suppliers based on goods or services of the supplier that are similar to the goods or services desired by the at least one buyer, and/or locations of suppliers that are proximate to locations of the buyer.

Additionally, or alternatively, selecting the set of the suppliers includes maintaining a company profile of each of the suppliers, and identifying suppliers that match a company profile of the buyer. Additionally, or alternatively, selecting the set of the suppliers includes mining data (also referred to as supplier recruitment) of suppliers 124 that are not associated with the supplier/buyer commerce network 110 through, for example, cloud networks 120.

For an embodiment, mining data of suppliers includes finding suppliers from other databases and/or reaching out, for example, through the internet to company (potential supplier) websites. That is, suppliers can be recruited that are a potential match with the buyer. The recruitment can be through the searching of databases (inside and outside of the supplier/buyer commerce network 110) and/or searching other company

Once the buyer has been matched to a set of suppliers, an electronic communication alerts the suppliers of a current interest by the buyer to acquire good and/or service that the suppliers 114, 124 provide. The electronic communication can be made, for example, by emailing the anonymously harvested information to the selected set of suppliers. Additionally, or alternatively, the electronic communication can be made to the suppliers by, faxing, phoning, tweeting, a small message system (sms), an RDF site summary (RSS) feeds, an application programming interface (API) based integration, and/or third party integrations.

For other embodiments, the communication can include uploading the anonymously harvested information to a website that is accessible by the selected set (additionally or alternatively, the website can be available to any supplier) of suppliers through, for example, the internet, phone applications and/or tablet applications. The selected set of suppliers can be directed to the website through various methods. For example, the suppliers can each be sent an email that includes a link to the website.

Advantageously, the suppliers are provided with an opportunity that includes a buyer that is presently within a buying cycle. That is, the buyer is seeking a good or service that the supplier provides at the time the supplier receives the electronic introduction.

An electronic introduction engine facilitates electronic introductions of interested suppliers 114, 124 to the buyer 112. The buyer 112 can then choose to interact with the interested suppliers 114, 124.

Embodiments include the company profile 118 being adaptively updated (by, for example, a commerce network server 111) as the company associated with the company profile 118 interacts with buyers 112, 122 and/or suppliers 114, 124. The company profile 118 can advantageously be used to generate a score for the company and/or match the company with other companies associated with the supplier/buyer commerce network 110. The company profile 118 is generally stored within a database associated with the supplier/buyer commerce network 110.

While the embodiments described are directed to a single company profile 118, it is to be understood that at least some of the described embodiments include multiple company profiles. For embodiments, each company profile corresponds with a different company associated with the supplier/buyer commerce network 110. The different company profiles provide a means for contrasting (for example, scoring) the different companies. Additionally, the different company profiles can be used to proactively match companies (suppliers 114 and buyers 112) associated with the supplier/buyer commerce network 110.

As shown, an embodiment of the company profile 118 includes four quadrants, wherein a first quadrant (A) includes self-reported information, a second quadrant (B) includes community information, a third quadrant (C) includes third party information, and fourth quadrant (D) includes aggregated activity information. It is to be understood that for some embodiments the company profile can include a subset of these quadrants, and for other embodiments, the company profile can include information in addition to the information of these four quadrants. The company profile 118 is a collection of information pertaining to the corresponding company that is associated with the network. The company profile allows other companies (suppliers 114 and/or buyers 112) to evaluate the company associated with the company profile 118. Clearly, the company profile can include fewer or more than the four quadrants.

The self-reported information (quadrant A) can be from (suppliers 114 and/or buyers 112) includes company provided information that can be received by the supplier/buyer commerce network and incorporated into the company profile. The self-reported information can be received in different ways. For example, a company may effectively “walk up” and join the supplier/buyer commerce network, or the company information can be loaded by the supplier/buyer commerce network 110 or from another database or application. For an embodiment, the public information becomes a part of the profile.

For embodiments, pieces of the self-reported information are used to drive additional processes in the supplier/buyer commerce network. That is, for example the self-reported information can include a DUNS number field. Once the supplier/buyer commerce network has the DUNS number, the supplier/buyer commerce network can provide financial risk score information on the supplier. The DUNS number can be used to drive communication with, for example, a third party. Additionally, as will be described, a matching process engine can analyze commodities (goods & services) a supplier has selected as providing, and the sales territories of the supplier, in order to match that supplier's profile against the business opportunities.

The community information (quadrant B) includes information that pertains to the company that is provided by suppliers 114 and buyers 112 associated with the network. The community information includes, for example, ratings. The ratings allow, for example, a buyer to rate any supplier that has responded to a business opportunity on the supplier/buyer commerce network 110.

Another aspect of the community information includes references. For example, a supplier may request a buyer to leave a reference for the supplier. For embodiments, the supplier solicits the reference by supplying the email address of the buyer, or otherwise identifies the buyer. To further facilitate community and parallel real world interactions, embodiments of the supplier/buyer commerce network allows other buyers to request contact with the author of any given reference. For embodiments, the subject of the reference (the supplier) is the gatekeeper in such an interaction and may decline or accept the third party's request to speak with a reference. For embodiments, the reference itself contains a few pieces of information, for example, a text narrative, industry of the buyer, and/or length of the business relationship.

The third party information (quadrant C) includes information that pertains to the company that is provided by a third party 170 who is typically not associated directly with the network. The third party information includes, for example, a business and credit rating provided by, for example, an established rating agency (such as, Dun & Bradstreet® (D&B)). The third party information can include financial risk information about suppliers. This can be provided, for example, using self-reported DUNS number information. The DUNS information can be validated with D&B using an API call. The validated information can be displayed back to the supplier for their approval. Once approved, the supplier/buyer commerce network basically has the supplier linked to a risk profile on D&B.

The aggregated activity information includes, for example, transactional activity of the company. The aggregated activity information includes information about suppliers and their performance on the supplier/buyer commerce network 110.

A useful piece of aggregated activity information included within the company profile is the number of transacting relationships that the company has with buyers/suppliers 112, 114 on the supplier/buyer commerce network 110, and/or transacting relationships the company has with buyers/suppliers 122, 124 of other commerce networks, such as cloud networks 120. This information provides a valuable picture of how many other companies the company is actively doing business with via the supplier/buyer commerce network 110, and the cloud networks 120. It is to be understood that doing business with other companies includes activities can include interactions that do not include money, good or services changing hands. If the supplier/buyer commerce network 110 is interfaced with cloud networks 120, the company profile can be made to be common (the same) between commerce network platforms. Therefore, real-time information can be utilized across the commerce and cloud network platforms 110, 120.

Examples of aggregated activity information include, but are not limited to, event invitations, invitations by revenue, transaction awards (for example, winning supplier bids), revenue ranges, and/or top bids by industry.

The interface between the supplier/buyer commerce network 110 and cloud networks 120 allows the supplier/buyer commerce network 110 to glean additional information that can be useful for enhancing the value of the company profile 118. For example, cloud network 120 can include sourcing and/or contract information and data. These embodiments determine commonality of suppliers/buyers across multiple private cloud networks. The different companies (buyer/sellers) are assigned unique identifiers by, for example, a unique ID engine, which allows the generation of a single view of the companies' behavior across multiple interactions (across the supplier/buyer commerce network 110 and the cloud networks 120). That is, for embodiments, one or more databases are associated with networks 110, 120 that maintain transactional activity of the company with other companies, and this transaction information for the company is identified by the unique identifier of the company. The unique ID engine can be operable, for example, on a server that is networked to the supplier/buyer commerce network 110.

Once the company has been assigned a unique identification by the unique ID engine 130, the supplier/buyer commerce network 110 imports (alternatively, the databases of the cloud networks 120 export) the activity information of the company from the databases of the cloud networks 120. While the unique ID engine 130 is shown as being separate from the supplier/buyer commerce network 110 in FIG. 1, it is to be understood that for other embodiments the unique ID engine is included within the supplier/buyer network 110.

The activity information from the databases of the cloud networks 120 is aggregated by an aggregation engine. For embodiments, the aggregation includes summing or ranking the activity information. For embodiments, the aggregation engine can be a computer or server that is a part of, or is connected to the supplier/buyer commerce network 110.

The company profile 118 that includes at least one or more of the four quadrants of information ((A) self-reported information, (B) community information, (C) third party information, and (D) aggregated activity information) can be further processed by a scoring engine that scores companies associated with the supplier/commerce network 110, and/or by a matching engine that matches the company with buyers 112 or sellers 114 associated with the supplier/commerce network 110. For embodiments, the scoring engine and the matching engine can be computers or servers that are a part of, or are connected to the supplier/buyer commerce network 110.

The supplier/buyer commerce network 110, the cloud networks 120 and the unique ID engine can each be implemented with one or more servers or computers (such as, a supplier/buyer commerce server, cloud network servers and a unique ID engine server). Additionally, the aggregation engine, the scoring engine and the matching engine can be each implemented with one or more servers, or they can all be implemented with a single server. Each of the supplier/buyer commerce network 110, the cloud networks 120 and the unique ID engine can be interconnected through, for example, the internet or any other type of network. Additionally, the buyers 112, the sellers 114 and the third party 170 can be connected to the supplier/buyer commerce network 110 through, for example, the internet or any other type of network.

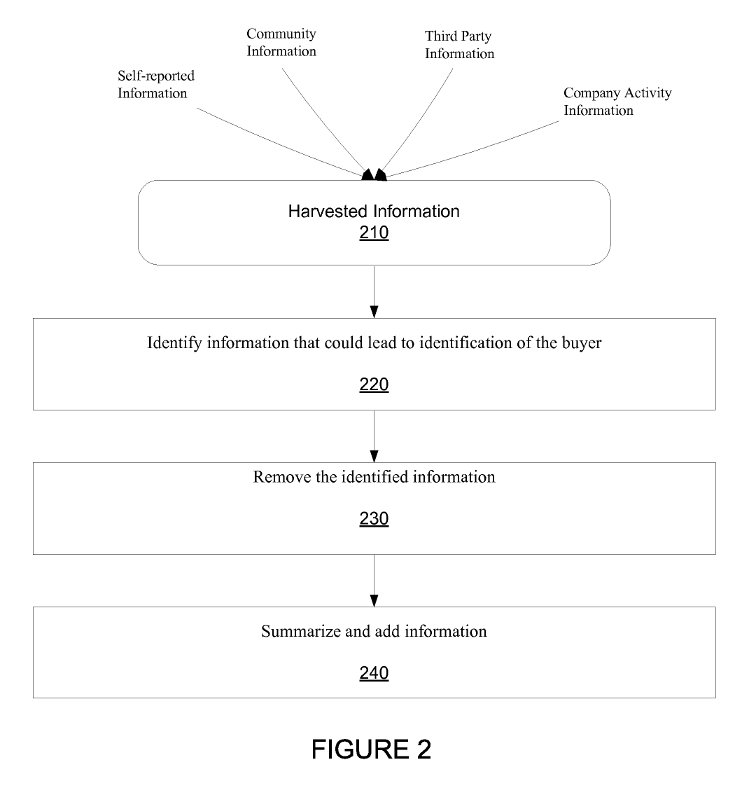

FIG. 2 is a flow chart that includes steps of an example of a method of harvesting and summarizing buyer information. A first step 210 includes harvesting information of the buyer. As shown, sources of buyer information include at least one of self-reported information, community information, third party information and/or company activity information. A second step 220 includes identifying what of the harvested information could lead to identification of the buyer. A third step 230 includes removing at least a portion of the information identified in the second step 220. A fourth step 240 includes summarizing, substituting and/or supplementing (while the following described embodiments may reference this step as summarizing, it is to be understood that the harvested information can additionally be substituted or supplemented) the harvested information that has been anonymized. The “summarized” information informs the suppliers about the buyer and what the buyer desires. As described, for an embodiment, the harvest information includes commodity information, such as, a commodity code of a good or service the buyer desires, a response information that indicates the time period in which the buyer would like to acquire the good or service, a product or service amount, and a location (such as, at the country level). Additionally, the harvested information can include anonymous buyer information.

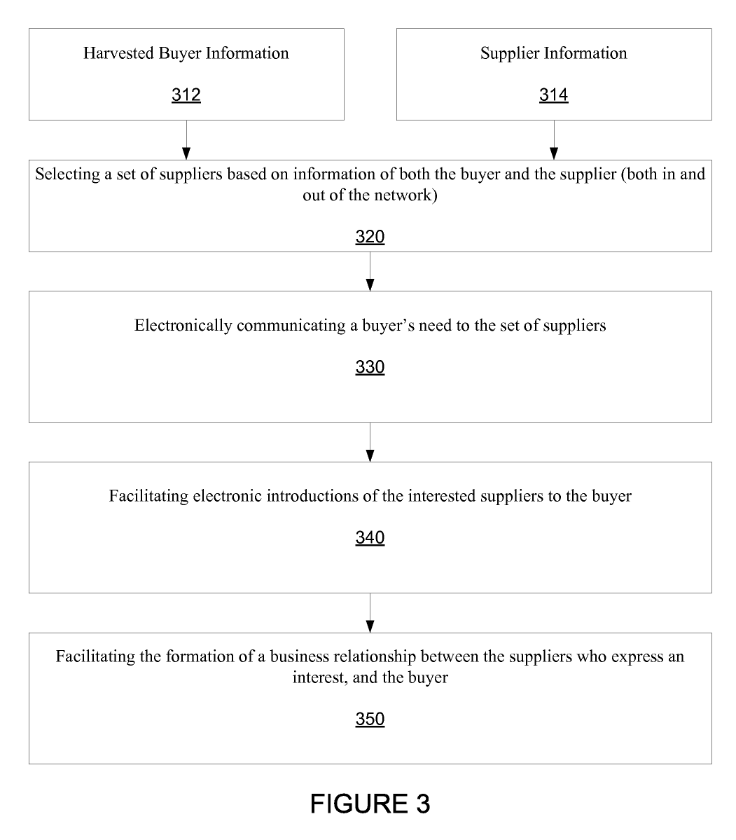

FIG. 3 is a flow chart that includes steps of an example of a method of matching a set of suppliers with a buyer. Harvested buyer information 312 and supplier information 314 are used to select a set of suppliers based on the information of both the buyer and the suppliers (320). That is, the information of the buyer and the suppliers is matched. A step 330 includes electronically communicating a buyer's needs to the set of suppliers. A step 340 includes facilitating electronic introductions of the interested suppliers to the buyer. A step 350 includes facilitating the formation of a business relationship between the suppliers who express an interest and the buyer.

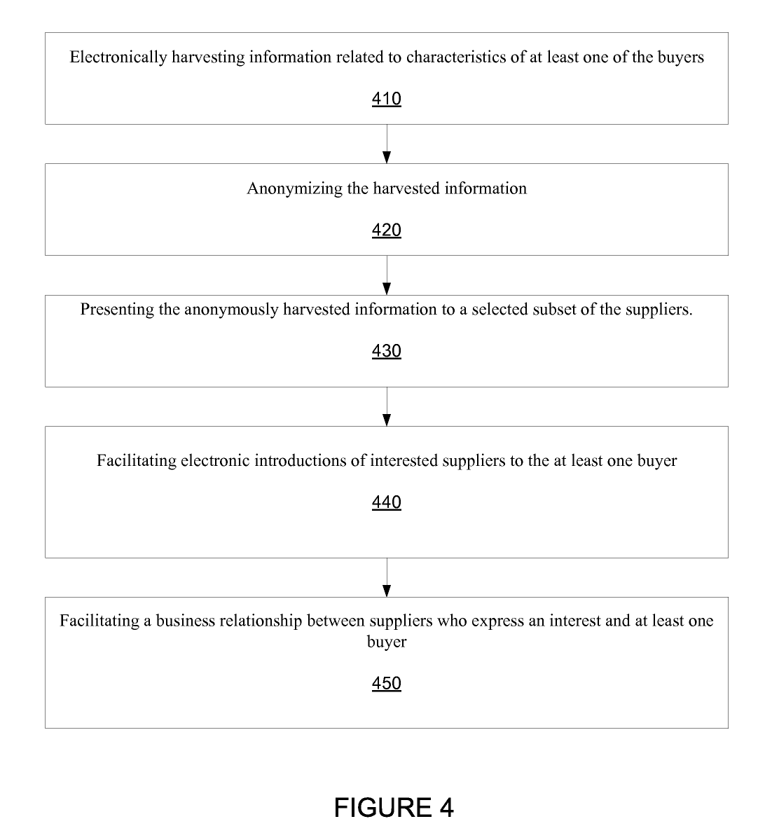

FIG. 4 is a flow chart that includes steps of an example of a method a supplier/buyer commerce network electronically introducing buyer and suppliers. A first step 410 includes electronically harvesting information related to characteristics of at least one of the buyers. A second step 420 includes anonymizing the harvested information. A third step 430 includes presenting the anonymously harvested information to a selected set of the suppliers. A fourth step 440 includes facilitating electronic introductions of interested suppliers to the at least one buyer. A fifth step 450 includes facilitating a formation of a business relationship between suppliers who express an interest and at least one buyer.

The supplier/buyer commerce network can include one or more servers which are networked. While the descriptions provided are directed to introducing suppliers to buyers, clearly the described embodiments include the introduction of buyers to suppliers as well.

As described, for an embodiment, the electronically harvested information includes commodity information, a response time-line, a product amount, and location information. Additionally, the harvested information can include information about the buyer which can be presented anonymously.

As described, for an embodiment, electronically harvesting information includes maintaining a company profile of each of the buyers. For a specific embodiment, maintaining a company profile of each of the buyers associated with the supplier/buyer commerce network includes collecting activity information of the buyer. For an embodiment, collecting activity information of the buyer includes monitoring a plurality of databases that each maintains activity information associated with the buyer, assigning a unique identification for the company across the plurality of databases, exporting the activity information associated with the buyer from each of the plurality of databases, and aggregating the activity information. The company profile of the buyer is updated with the aggregated activity information of the company. For an embodiment, the company profile of the buyer further includes at least one of community information, self-reported information and third party information.

For an embodiment, anonymizing the harvested information includes redacting information within the harvested information that could be used to identify the buyer. For an embodiment, the harvested information in anonymized as selected by the buyer. The buyer can select the information to be minimally anonymous, or not anonymous at all.

Embodiments further include summarizing the harvested buyer information. This can include, for example, adding selected information. The added back information includes information about the buyer, for example, RFI/RFQ/Reverse Auction, Commodities, Location, Project Size, Industry, Revenue, State, employees, years in business, dollar amounts sourced on buyer/seller commerce network, typical commodities sourced. Additionally, it is to be understood that summarizing here can additionally include substituting information. For example, a buyer may be interested in buying beakers. The summarizing can include replacing the product term with a more generic term, such as, laboratory equipment. For non anonymous versions, the buyer profile can be published. For embodiments, the added selected information is information associated with identification of a buying opportunity.

For an embodiment, selecting the set of suppliers includes identifying suppliers of goods or services that are similar to the goods or services desired by the at least one buyer, and/or identifying suppliers of goods or services that are located proximate to the at least one buyer.

For an embodiment, selecting the set of the suppliers includes maintaining a company profile of each of the suppliers, and identifying suppliers that match a company profile of the buyer. For an embodiment maintaining the company profile of each of the suppliers associated with the supplier/buyer commerce network includes collecting activity information of the supplier. For an embodiment, collecting activity information of the supplier includes monitoring a plurality of databases that each maintains activity information associated with the supplier, assigning a unique identification for the company across the plurality of databases, exporting the activity information associated with the buyer from each of the plurality of databases, and aggregating the activity information. The company profile of the supplier is updated with the aggregated activity information of the company.

As described, embodiments for presenting the anonymously harvested information to the selected set of the suppliers include electronically communicating the anonymously harvested information to each of the selected set of the suppliers. The electronic communication can be of one or more of many different forms, such as, emailing the anonymously harvested information to the selected set of suppliers. Other example of electronic communication include, but are not limited to, faxing, phoning, tweeting, sms messaging, RSS feeding, communicating through API based integration, and/or communicating through third party integrations.

As described, an embodiment for presenting the anonymously harvested information to a selected set of the suppliers, includes uploading the anonymously harvested information to a website that is accessible by the selected set of suppliers. The website can be accessed through one of many different means, such as, through the internet (web), through a mobile device, smart phone application and/or tablet applications.

As described, for an embodiment facilitating formation of a business relationship between suppliers who express an interest and the at least one buyer includes providing an electronic link to the buyer within an email. Clearly, the link can be communicated in other ways, such as, described above.

An embodiment includes aggregating the electronic introductions of buyers and suppliers. For an embodiment, the aggregating is based on certain attributes, and further includes presenting the harvested information. Examples of attributes include types of commodities, locations, industries, and/or project costing amounts. The publishing makes the aggregated data available, for example, to those who are doing industry research and/or benchmarking.

Embodiments include electronically communicating a buyer response digest to the buyer which includes the aggregated electronic introductions, providing a method for the buyer to respond to at least one of the aggregated electronic introductions. The digest provides a convenient way for the buyer to search, review and respond to one or more electronic introductions of an aggregation of electronic introductions received from the suppliers.

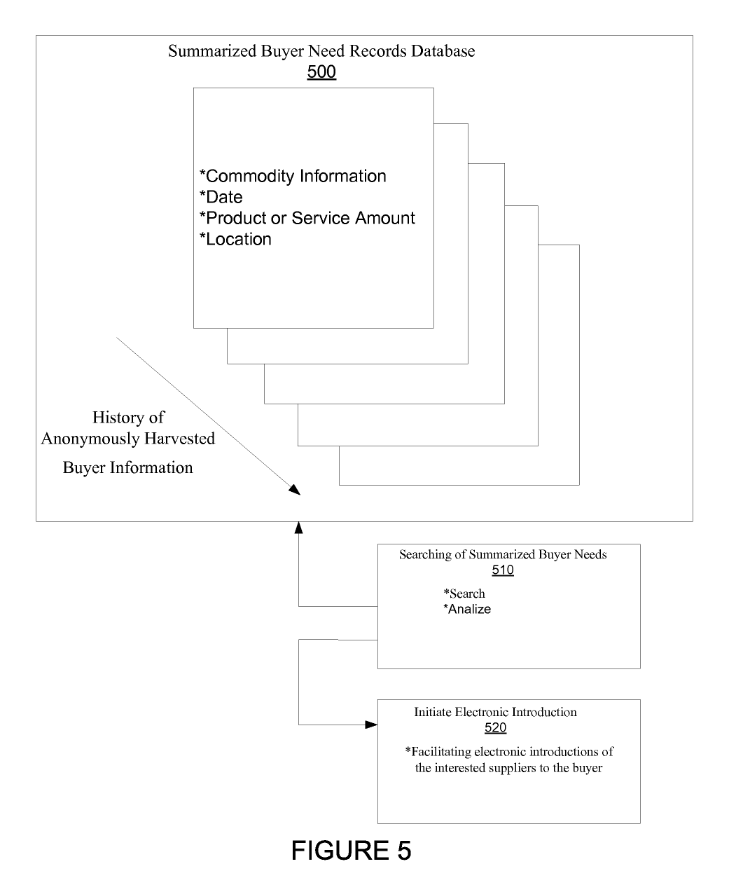

FIG. 5 illustrates an example of historical records of harvested and summarized buyer information. An embodiment includes creating a database 500 of summarized buyer need records (past harvested and summarized buyer information). The database 500 allows suppliers to search and identify current and past records of harvested buyer information that can be used to create new electronic introductions. That is, as shown in FIG. 5, current or past records of harvested buyer information can be accessed from the database 500, allowing suppliers to access the past summarized buyer need records, which can lead to future electronic introductions.

For an embodiment, the supplier/buyer commerce network includes searching functionality (510) that allows, for example, suppliers to search the electronic introductions of the electronic introduction database 500. Additionally, the supplier/buyer commerce network includes functionality (520) that allows the suppliers to initiate electronic introductions of interested suppliers to buyers, based on the summarized buyer need records of the electronic introduction database 500.

For embodiments, facilitating formation of a business relationship between suppliers who express an interest and the at least one buyer includes managing a collaborative exchange of information between the buyer and the at least one supplier, while maintaining the buyer anonymity for as long as the buyer desires. That is, the buyer can maintain a level of anonymity as far along in the collaborative information exchange as the buyer selects.

For other embodiments, facilitating formation of a business relationship between suppliers who express an interest and the at least one buyer includes interested suppliers electronically expressing interest in the buyer by submitting an introduction to a buyer's application, and the buyer at least one of electronically indicating no interest, electronically indicating a lack of present interest but indicating a chance of a future interest, or electronically indicating a present interest.

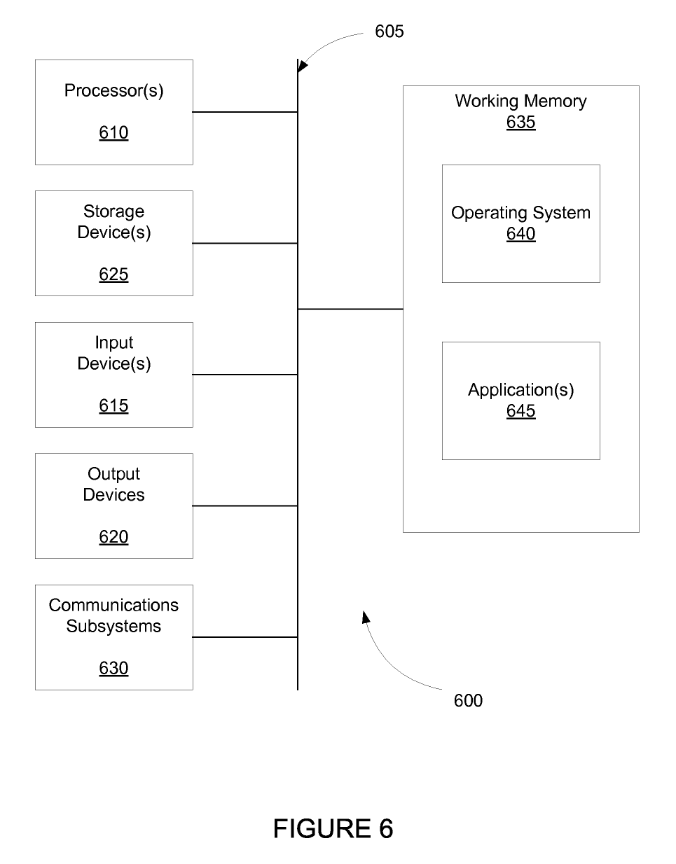

FIG. 6 shows a schematic illustration of one embodiment of a computer system that can perform the methods of the described embodiment, and/or can function as, for example, a supplier/buyer commerce network electronically introducing buyers and suppliers. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605 (or may otherwise be in communication, as appropriate). The hardware elements can include one or more processors 610, communication subsystems 630, one or more input devices 615, which can include without limitation a mouse, a keyboard and/or the like; and one or more output devices 620, which can include without limitation a display device, a printer and/or the like. The computer system 600 may further include (and/or be in communication with) one or more storage devices 625. The computer system 600 also can comprise software elements, shown as being located within the working memory 635, including an operating system 640 and/or other code, such as one or more application programs 645, which may comprise computer programs of the described embodiments, and/or may be designed to implement methods of the described embodiments and/or configure systems of the embodiments as described herein.

Another embodiment includes a program storage device readable by a machine (of the supplier/buyer commerce network), tangibly embodying a program of instructions executable by the machine to perform a method of a supplier/buyer commerce network electronically introducing buyers and suppliers. The method performed includes collecting electronically harvesting information related to characteristics of at least one of the buyers, anonymizing the harvested information, presenting the anonymously harvested information to a selected set of the suppliers, and facilitating formation of a business relationship between suppliers who express an interest in the at least one buyer.

Although specific embodiments have been described and illustrated, the embodiments are not to be limited to the specific forms or arrangements of parts so described and illustrated.

What is claimed:

1. A computer-method of a supplier/buyer commerce network electronically introducing buyers and suppliers, comprising:
electronically harvesting information related to characteristics of at least buyer;
anonymizing the harvested information;
presenting the anonymously harvested information to a selected set of the suppliers;
facilitating electronic introductions of interested suppliers to the at least one buyer;
facilitating formation of a business relationship between suppliers who express an interest in the at least one buyer.

2. The computer-method of claim 1, wherein electronically harvesting information comprises commodity information, a response time-line, a product amount, and location information.

3. The computer-method of claim 1, wherein electronically harvesting information comprises maintaining a company profile of each of the buyers.

4. The computer-method of claim 3, wherein maintaining a company profile of each of the buyers associated with the supplier/buyer commerce network, comprises:
collecting activity information of the buyer, comprising;
monitoring a plurality of databases that each maintain activity information associated with the buyer;
assigning a unique identification for the company across the plurality of databases;
exporting the activity information associated with the buyer from each of the plurality of databases;
aggregating the activity information;
updating the company profile of the buyer with the aggregated activity information of the company.

5. The computer-method of claim 4, wherein the company profile of the buyer further comprises self-reported information.

6. The computer-method of claim 5, wherein the company profile of the buyer further comprises at least one of community information, and third party information.

7. The computer-method of claim 1, wherein anonymizing the harvested information comprises redacting information within the harvested information that could be used to identify the buyer.

8. The computer-method of claim 1, wherein the harvested information in anonymized as selected by the buyer.

9. The computer-method of claim 1, further comprising summarizing the anonymized harvested information, comprising at least one of adding and substituting selected information.

10. The computer-method of claim 9, wherein the added selected information comprises information associated with identification of a buying opportunity.

11. The computer-method of claim 3, further comprising summarizing and anonymizing the company profile of the buyer.

12. The computer-method of claim 1, further comprising selecting the set of the suppliers comprising:
identifying suppliers of goods or services that are similar to the goods or services desired by the at least one buyer;
identifying suppliers of goods or services that are located proximate to the at least one buyer.

13. The computer-method of claim 1, further comprising selecting set of the suppliers comprising maintaining a company profile of each of the suppliers, and identifying suppliers that match a company profile of the buyer.

14. The computer-method of claim 13, wherein maintaining the company profile of each of the suppliers associated with the supplier/buyer commerce network, comprising:
collecting activity information of the supplier, comprising;
monitoring a plurality of databases that each maintain activity information associated with the supplier;
assigning a unique identification for the company across the plurality of databases;
exporting the activity information associated with the buyer from each of the plurality of databases;
aggregating the activity information;
updating the company profile of the supplier with the aggregated activity information of the company.

15. The computer-method of claim 1, wherein presenting the anonymously harvested information to a selected set of the suppliers, comprises electronically communicating the anonymously harvested information to each of the selected set of the suppliers.

16. The computer-method of claim 1, wherein presenting the anonymously harvested information to a selected set of the suppliers, comprises uploading the anonymously harvested information to a website that is accessible by the selected set of suppliers.

17. The computer-method of claim 1, wherein facilitating formation of a business relationship between suppliers who express an interest and the at least one buyer comprises:
managing a collaborative exchange of information between the buyer and the at least one supplier, while maintaining the buyer anonymity for as long as the buyer desires.

18. The computer-method of claim 1, wherein facilitating formation of a business relationship between suppliers who express an interest and the at least one buyer comprises:
interested suppliers electronically expressing interest in the buyer by submitting an introduction to a buyer's application;
the buyer at least one of electronically indicating no interest, electronically indicating a lack of present interest a potential for future interest, or electronically indicating a present interest.

19. The computer-method of claim 1, further comprising aggregating the electronically introductions of suppliers to buyers.

20. The method of claim 19, wherein the aggregating is based on certain attributes, and further comprising presenting the harvested information.

21. The method of claim 19, further comprising electronically communicated a buyer response digest to the buyer which includes the aggregated electronic introductions, providing a method for the buyer to respond to at least one of the aggregated electronic introductions.

22. The method of claim 19, further comprising:
creating a database of summarized buyer need records;
allowing the supplier to search and identify past summarized buyer need records that can be used to create new electronic introductions.

23. A supplier/buyer commerce network that electronically introduces buyers and suppliers, comprising:
electronically harvesting, by a commerce network server, information related to characteristics of at least one buyer;
anonymizing, by the commerce network server, the harvested information;
presenting the anonymously harvested information to a selected set of the suppliers;
facilitating, by the commerce network server electronic introductions of interested suppliers to the at least one buyer;
facilitating, by the commerce network server, a formation of a business relationship between suppliers who express an interest and the at least one buyer.

24. A program storage device readable by a machine, tangibly embodying a program of instructions executable by the machine to perform electronically introductions buyers and suppliers, comprising:
electronically harvesting information related to characteristics of at least buyer;
anonymizing the harvested information;
presenting the anonymously harvested information to a selected set of the suppliers;
facilitating electronic introductions of interested suppliers to the at least one buyer;
facilitating formation of a business relationship between suppliers who express an interest in the at least one buyer.

25. A computer-method of a supplier/buyer commerce network electronically introducing buyers and suppliers, comprising:
electronically harvesting information related to characteristics of at least buyer;
selecting a set of suppliers based on the harvested information of the at least one buyer;
electronically introducing the set of suppliers to the at least one buyer, and presenting the harvest information to the set of the suppliers;
facilitating formation of a business relationship between suppliers who express an interest in the at least one buyer.
